(19) United States
(12) Patent Application Publication
(10) Pub. No.: US 2019/0180097 A1
(43) Pub. Date: Jun. 13, 2019

(54) SYSTEMS AND METHODS FOR AUTOMATED CLASSIFICATION OF REGULATORY REPORTS

(71) Applicant: Walmart Apollo, LLC, Bentonville, AR (US)

(72) Inventors: David Ferguson, Bentonville, AR (US); Saba Beyene, Fayetteville, AR (US); Darren Shadduck, Bentonville, AR (US); Srinivas Talluri, Bentonville, AR (US)

(21) Appl. No.: 16/215,006

(22) Filed: Dec. 10, 2018

Related U.S. Application Data
(60) Provisional application No. 62/596,879, filed on Dec. 10, 2017.

(51) Int. Cl. G06K 9/00; G06K 9/62; G06N 20/10; G06N 3/02; G06T 7/11

(52) U.S. Cl. CPC G06K 9/00463; G06K 9/6282; G06K 2209/01; G06N 3/02; G06T 7/11; G06N 20/10

(57) ABSTRACT

Exemplary embodiments relate systems, methods and computer readable medium for automatically processing and classifying regulatory reports. An example system includes an image processing module, an image segmentation module, a segment filtering module, a classification module and a validation module.

### CROSS-REFERENCE TO RELATED PATENT APPLICATIONS

This application claims priority to U.S. Provisional Application No. 62/596,879 filed on Dec. 10, 2017, the content of which is hereby incorporated by reference in its entirety.

### BACKGROUND

Facilities of retailers and organizations open to the public and offering goods and services are often inspected to ensure that they satisfy certain compliance criteria. The violation or compliance with these criteria are noted by regulatory officers or inspectors using a variety of forms.

### BRIEF DESCRIPTION OF DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram showing a document classification system implemented in modules, according to an exemplary embodiment;

FIG. 2 is a flowchart showing an example method for the document classification system, according to an exemplary embodiment;

FIG. 3 schematically illustrates an example architecture to implement the document classification system, according to an exemplary embodiment;

FIG. 4 is a schematic illustrating an example process flow for the document classification system, according to an exemplary embodiment;

FIG. 5 is a schematic illustrating example data processing components for the document classification system, according to an exemplary embodiment;

FIG. 6 shows an example user interface for the document classification system, according to an exemplary embodiment;

FIG. 7 illustrates a network diagram depicting a system for implementing a distributed embodiment of the document classification system, according to an exemplary embodiment; and

FIG. 8 is a block diagram of an exemplary computing device that can be used to implement exemplary embodiments of the document classification system described herein.

### DETAILED DESCRIPTION

Described in detail herein are systems and methods for automated classification of regulatory reports. Exemplary embodiments analyze document images of disparate regulatory reports, perform image processing to prepare images for further analysis, segment images into text blocks and determine relevant text blocks from the resultant segments, and analyze the individual text blocks to classify the regulatory report information into categories and sub-categories.

A large retailer or organization may encounter thousands of inspectors annually. These inspectors come from different agencies, inspect different subject matter areas, and issue regulatory reports outlining violations and compliances with certain standards. The regulatory reports are scanned and provided as input to the document classification system described herein.

The exemplary document classification system described herein is capable of processing and classifying disparate regulatory reports that are inputted in the system as scanned document images. The disparate regulatory reports, which may be prepared by a variety of persons or regulatory compliance officers, may relate to a variety of inspection areas (food and safety, building, fire, etc.).

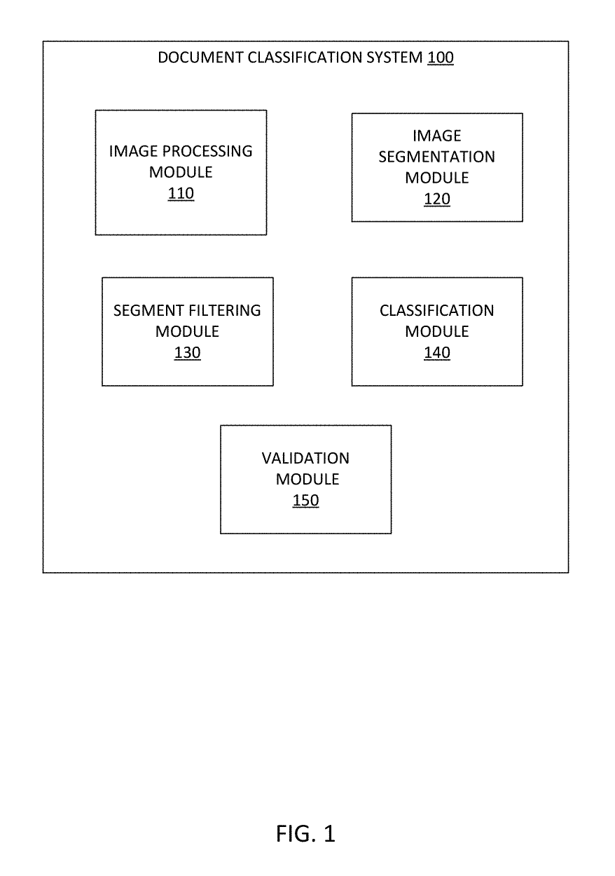

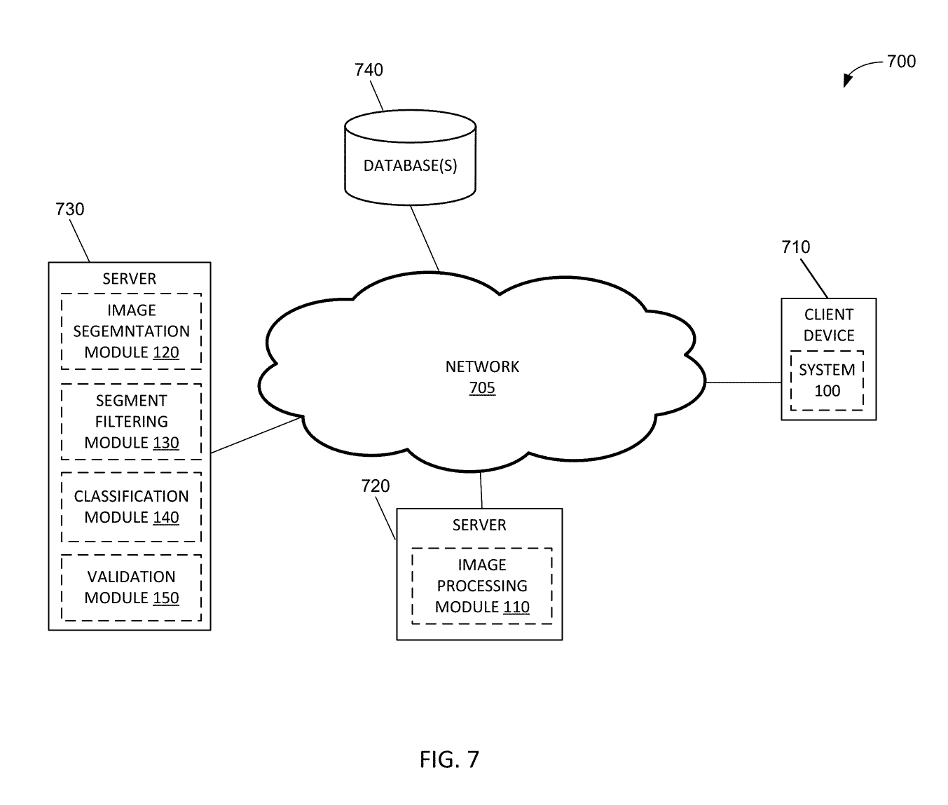

FIG. 1 is a block diagram showing a document classification system 100 in terms of modules according to an exemplary embodiment. One or more of the modules may be implemented using device 710, and/or server 720, 730 as shown in FIG. 7. The modules include an image processing module 110, an image segmentation module 120, a segment filtering module 130, a classification module 140, and a validation module 150. The modules may include various circuits, circuitry and one or more software components, programs, applications, or other units of code base or instructions configured to be executed by one or more processors. In some embodiments, one or more of modules 110, 120, 130, 140,150 may be included in server 720 and/or server 730. Although modules 110, 120, 130, 140, and 150 are shown as distinct modules in FIG. 1, it should be understood that modules 110, 120, 130, 140, and 150 may be implemented as fewer or more modules than illustrated. It should be understood that any of modules 110, 120, 130, 140, and 150 may communicate with one or more components included in system 700 (FIG. 7), such as client device 710, server 720, server 730, or database(s) 740.

The image processing module 110 may be a software or hardware implemented module configured to process document images of regulatory reports, including cleaning the images, removing noise from the images, aligning the images, and preparing the images for further processing and automatic classification.

The image segmentation module 120 may be a software or hardware implemented module configured to segment each document image into multiple defined smaller segments, and convert each defined segment into corresponding text blocks using optical character recognition (OCR).

The segment filtering module 130 may be a software or hardware implemented module configured to identify relevant segments by analyzing the corresponding text blocks and determining that the segment indicates a regulatory violation. The segment filtering module 130 may also be configured to separate relevant segments into separate or individual violations.

The classification module 140 may be a software or hardware implemented module configured to execute a trained machine learning model on the relevant segments of the document images, and automatically classify each of the segments into regulatory categories and sub-categories. The classification module 140 may also be configured to transmit data relating to the classification of each segment to a client device displaying a user interface. In example embodiments, the classification module 140 is configured to retrain the machine learning model based on feedback received from a user.

The validation module 150 may be a software or hardware implemented module configured to receive input from the client device via the user interface indicating the classification of the segments determined by the classification module 140 is accurate or inaccurate. The validation module 150 is configured to transmit the input as feedback to the classification module 140 to retrain the machine learning model.

In an example embodiment, the document classification system 100 can be implemented on one or more computing devices. As a non-limiting example, implementation of the system 100 can take the form of one or more computing devices implemented as one or more physical servers or one or more computing device implementing one or more virtual servers. Hardware utilized for the system 100 can be distributed across logical resources allocated for the system that can be housed in one server, or distributed virtually across multiple pieces of hardware. It will be appreciated that the functionality of the modules of the document classification system 100 described herein may be combined or separated into a lesser or greater number of modules than those described with reference to FIG. 1.

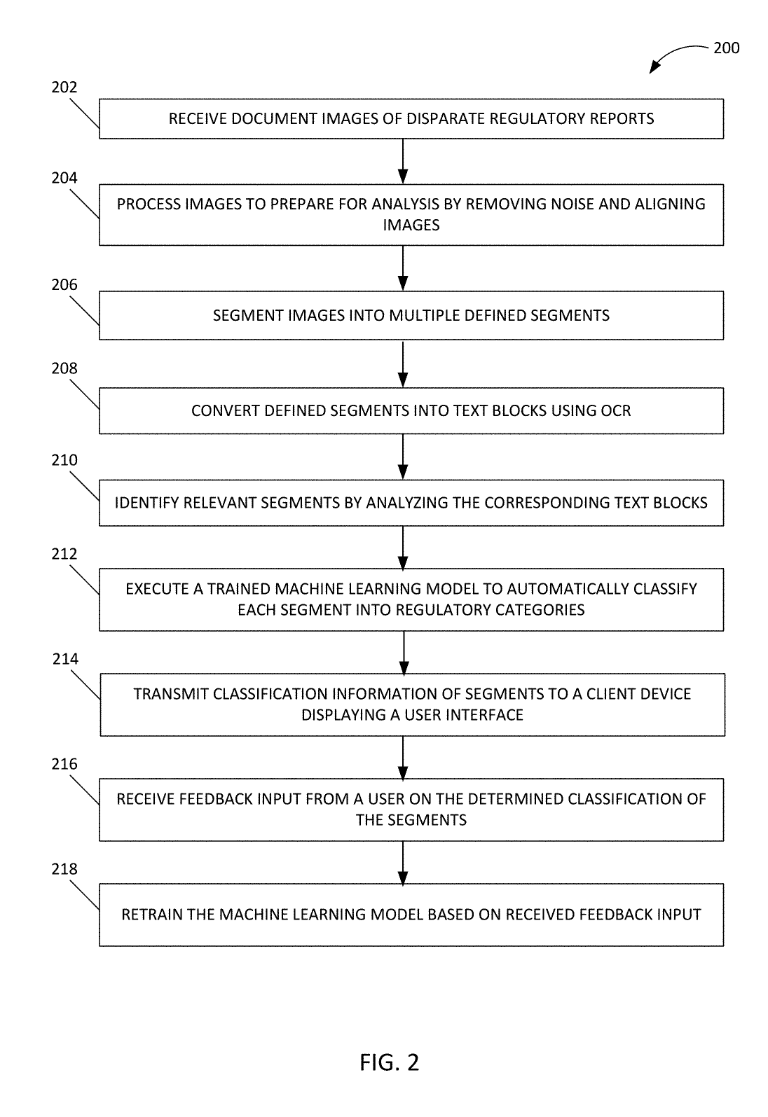

FIG. 2 is a flowchart showing an example method 200 for the document classification system, according to an exemplary embodiment. The method 200 may be performed using one or more modules of system 100 described above.

At step 202, the document classification system 100 receives document images of disparate regulatory reports. The images are stored in a database (e.g., database(s) 740). At step 204, the image processing module 110 processes the images to prepare them for further analysis. The image processing module 110 removes noise and aligns images, and prepares them for OCR.

At step 206, the image segmentation module 120 segments images into multiple smaller defined segments. At step 208, the image segmentation module 120 converts the defined segments into text blocks using OCR.

At step 210, the segment filtering module 130 identifies relevant segments by analyzing the corresponding text blocks. The system 100 identifies relevant segments as segments that include text indicating violation of compliance standards.

At step 212, the classification module 140 executes a trained machine learning model to automatically classify each segment into regulatory categories. Example categories include, but are not limited to, food safety, building, fire, and the like. In an example embodiment, the classification module 140 further classifies each segment into sub-categories, for example, fruits and vegetables, stairs, building structure, dirty stove or kitchen, alarms, detectors, and the like. In an example embodiment, the classification module 140 further classifies each segment by a brief description, for example, quality check/issue. Other categories and subcategories are possible within the scope of the present invention such as, but not limited to those listed in Appendix A attached hereto.

At step 214, the classification module 140 transmits classification information of the segments to a client device (e.g., device 710). The client device displays a user interface. The classification information is displayed in the user on the client device.

At step 216, the validation module 150 receives feedback input from the user via the user interface on the classification of the segments determined by the classification module 140. The feedback input from the user may indicate whether a classification is accurate or inaccurate. In case the classification is inaccurate, the user may also provide the correct classification for a particular text segment containing a violation. The user may also provide feedback with respect to whether the text segment is relevant or irrelevant (that is, whether the text segment contains a violation or not).

At step 218, the classification module 140 retrains the machine learning model based on the feedback input received from the user.

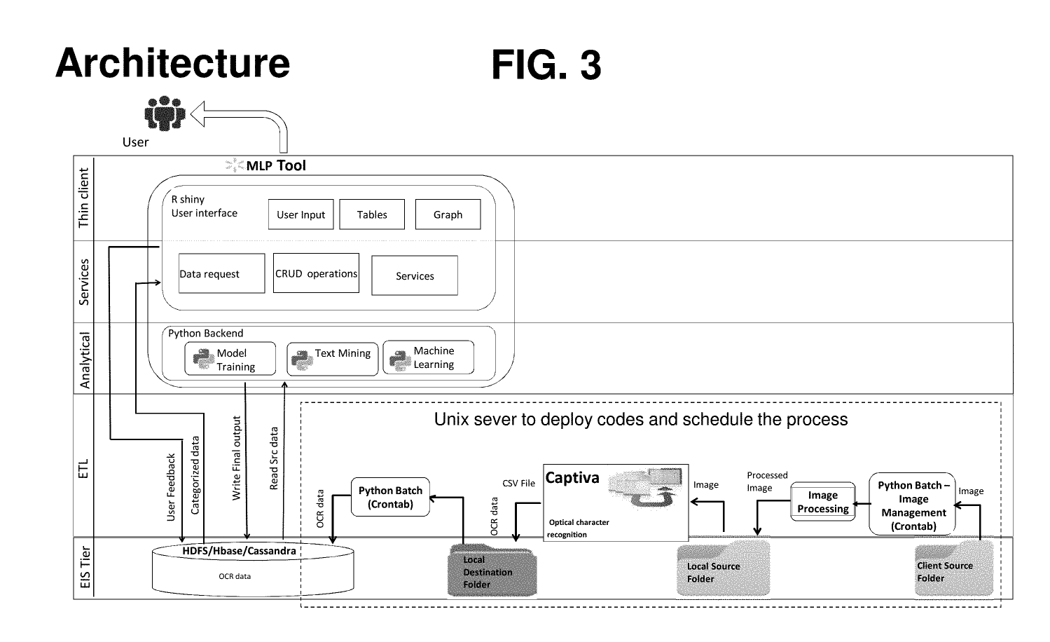

FIG. 3 schematically illustrates an example architecture to implement the document classification system 100, according to an exemplary embodiment. The document classification system 100 includes a server configured to deploy software code and schedule image processing of document images. In an example embodiment, the system 100 includes a Python backend to perform model training, text mining and machine learning using the input images. In an example embodiment, OCR is performed using software provided by Captiva™. The image is cleaned up during the image processing stage where each section of text/table from the images are segmented to individual blocks of text and are classified into relevant category/subcategory. This output is stored into a database. A user interface is provided as a thin client on a client device to receive user feedback. The user feedback is stored in the database and used to retrain the machine learning model.

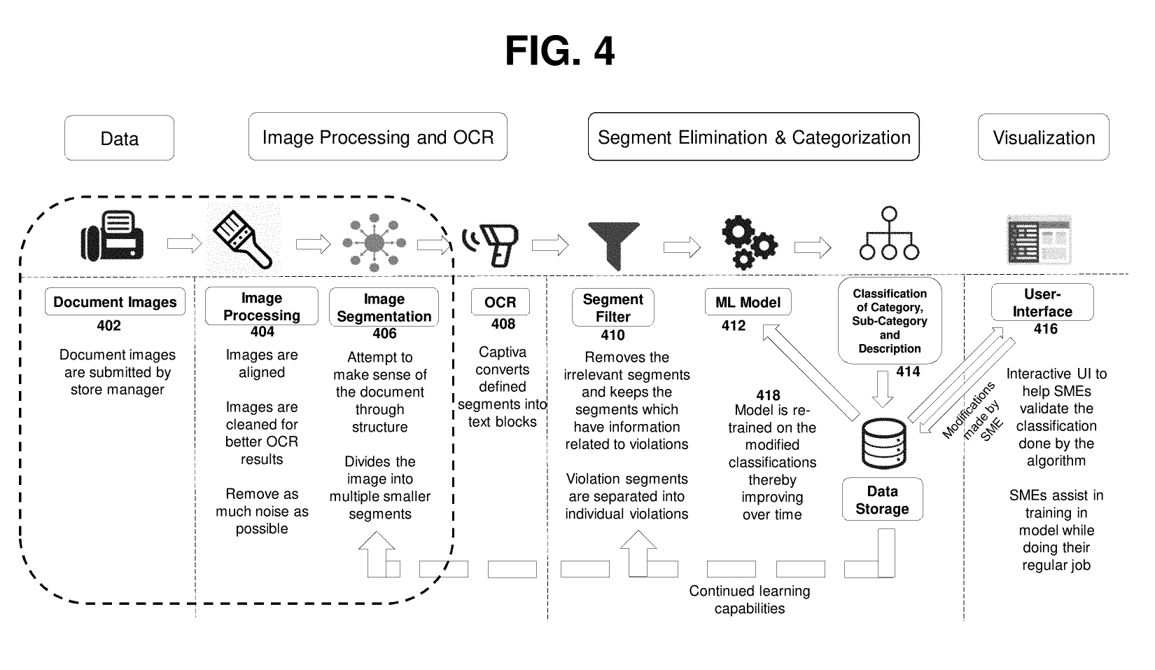

FIG. 4 is a schematic illustrating an example process flow for the document classification system 100, according to an exemplary embodiment. The process for the document classification system 100 begins at step 402 where document images of regulatory reports are submitted to the system. At step 404, the document images are processed. The image processing includes aligning of the images, cleaning the images for better OCR results, and removing noise from the images.

At step 406, the images are segmented into smaller multiple segments based on structure of the document. At step 408, the defined segments are converted into text blocks using OCR. In an example embodiment, Captiva™ is used to perform OCR on the segments. At step 410, the segments are filtered. The irrelevant segments are removed from analysis, and the relevant segments are kept for analysis. The relevant segments contain information related to violations reported in the regulatory reports. The relevant segments containing violations are separated into individual violations.

The individual violation segments are input to a machine learning model at step 412. At step 414, the machine learning model classifies the relevant segments containing violations into categories, sub-categories, and description. The machine learning model analyzes the text within the relevant segments to identify a category, sub-category, and description for the segment. At step 416, an interactive user interface is provided on a client device to a user that enables users to validate the classification of the relevant segments performed by the system 100. The users provide feedback via the user interface to correct or improve the classification of violation segments. At step 418, the machine learning model is retrained based on the feedback provided by the users. It should be appreciated that other types of information other than violations may also be classified by the system.

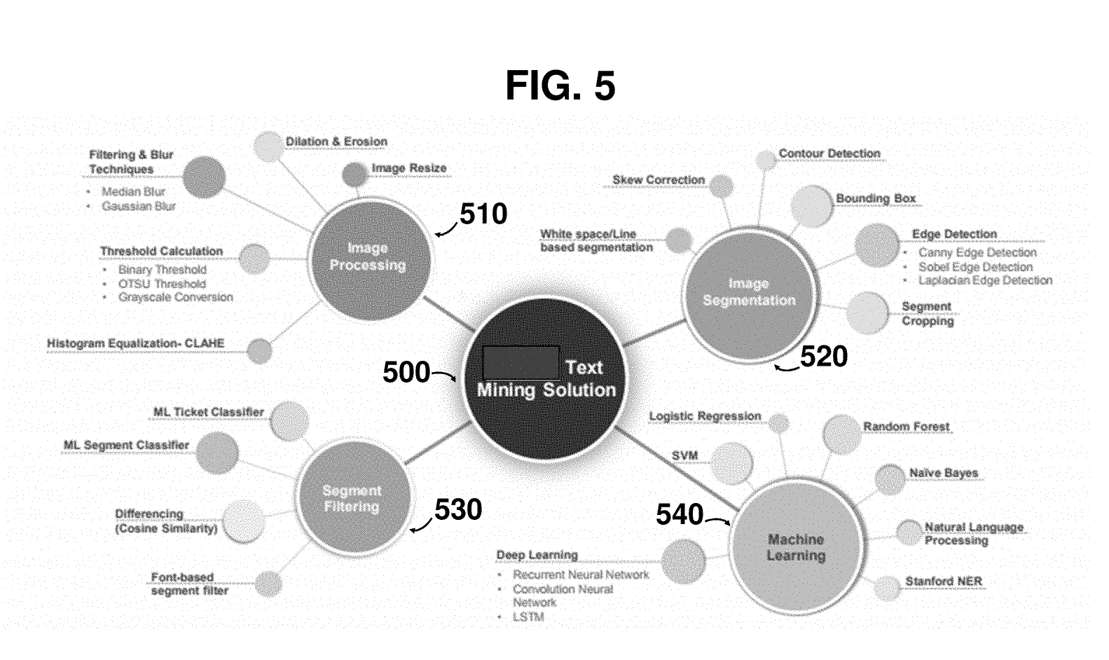

FIG. 5 is a schematic illustrating example data processing components for the document classification system 100, according to an exemplary embodiment. Text mining solution 500 includes various components, for example, image processing 510, image segmentation 520, segment filtering 530, and machine learning 540. Each component shown in FIG. 5 may be a software or hardware implemented component and may be configured to perform various functionalities described herein.

In an example embodiment, the image processing component 510 cleans up document images, removes noise, and prepares images for further processing. For example, the image processing component 510 implements image resizing techniques, dilation and erosion image processing techniques, filtering and blur image processing techniques (including median blur and Gaussian blur), threshold calculation image processing techniques (including binary threshold, Otsu threshold, grayscale conversion), and adaptive histogram equalization (including contrast limited AHE). In some embodiments, the functionalities of the image processing component 510 described here are performed by the image processing module 110 described in relation to FIG. 1.

In an example embodiment, the image segmentation component 520 analyzes document images to further comprehend its content and divides the image into multiple smaller segments. For example, the image segmentation component 520 implements white space and line space based segmentation, skew correction techniques, contour detection, bounding box techniques, edge detection (including canny edge detection, sobel edge detection, laplacian edge detection), and segment cropping. In some embodiments, the functionalities of the image segmentation component 520 described here are performed by the image segmentation module 120 described in relation to FIG. 1.

In an example embodiment, the segment filtering component 530 analyzes the segments created by image segmentation steps, and filters the segments to identify relevant segments that indicate a regulatory violation. For example, the segment filtering component 530 implements machine learning ticket classifier techniques, machine learning segment classifier techniques, differencing techniques (including cosine similarity), and font-based segment filtering. In some embodiments, the functionalities of the segment filtering component 530 described here are performed by the segment filtering module 130 described in relation to FIG. 1.

In an example embodiment, the machine learning component 540 classifies the filtered segments into violation categories and sub-categories using various machine learning techniques. For example, the machine learning component 540 implements support vector machine (SVM) model, logistic regression, random forest decision tree learning, naïve bayes, natural language processing, Stanford natural language processing (Stanford NER), and deep learning neural networks (including recurrent neural network, convolution neural network, long short-term memory (LSTM)). In some embodiments, the functionalities of the machine learning component 540 described here are performed by the classification module 140 described in relation to FIG. 1.

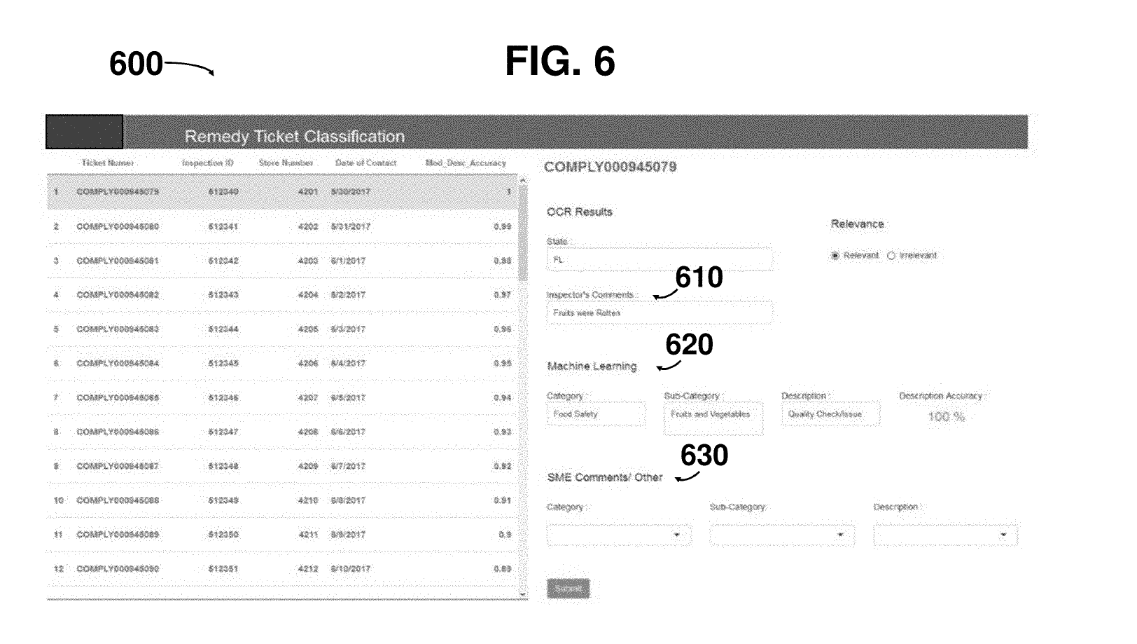

FIG. 6 shows an example user interface 600 for the document classification system, according to an exemplary embodiment. The user interface 600 may be displayed on the client device 710 of FIG. 7. A user may review the screen and provide feedback on the automated classification performed by the system 100. The user interface 600 displays text identified by the system 100 from document images as being relevant to a violation (see screen portion labeled 610). In this example, the system 100 recognized text “Fruits were Rotten” as indicating a violation reported in the regulatory report corresponding to the document image. The user interface 600 also displays the category and sub-category that the system 100 classified the document image under (see screen portion labeled 620). As shown in FIG. 6, the system 100 classified the document image under category: Food Safety, and sub-category: Fruits and Vegetables. In example embodiments, the system 100 also assigns a description to relevant text that further explains the violation indicated in the regulatory report. In this example, the description assigned by the system 100 is “Quality check/Issue.” The user interface 600 also enables a user to enter input validating the classification determined by the system 100. For example, the user can provide input indicating the classification is accurate. If the classification is inaccurate, then the user can input the correct category, sub-category and description in the user interface (see screen portion labeled 630). The feedback provided by the user via the user interface 600 is transmitted to the system 100 to retrain the machine learning model. In some embodiments, the system 100 automatically generates a description accuracy metric, which is displayed in the user interface (see Mod_Desc_Accuracy field in user interface 600).

FIG. 7 illustrates a network diagram depicting a system 700 for implementing a distributed embodiment of the automated document classification system, according to an example embodiment. The system 700 can include a network 705, client device 710, multiple servers, e.g., server 720 and server 730, and database(s) 740. Each of components 710, 720, 730, and 740 is in communication with the network 705.

In an example embodiment, one or more portions of network 705 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

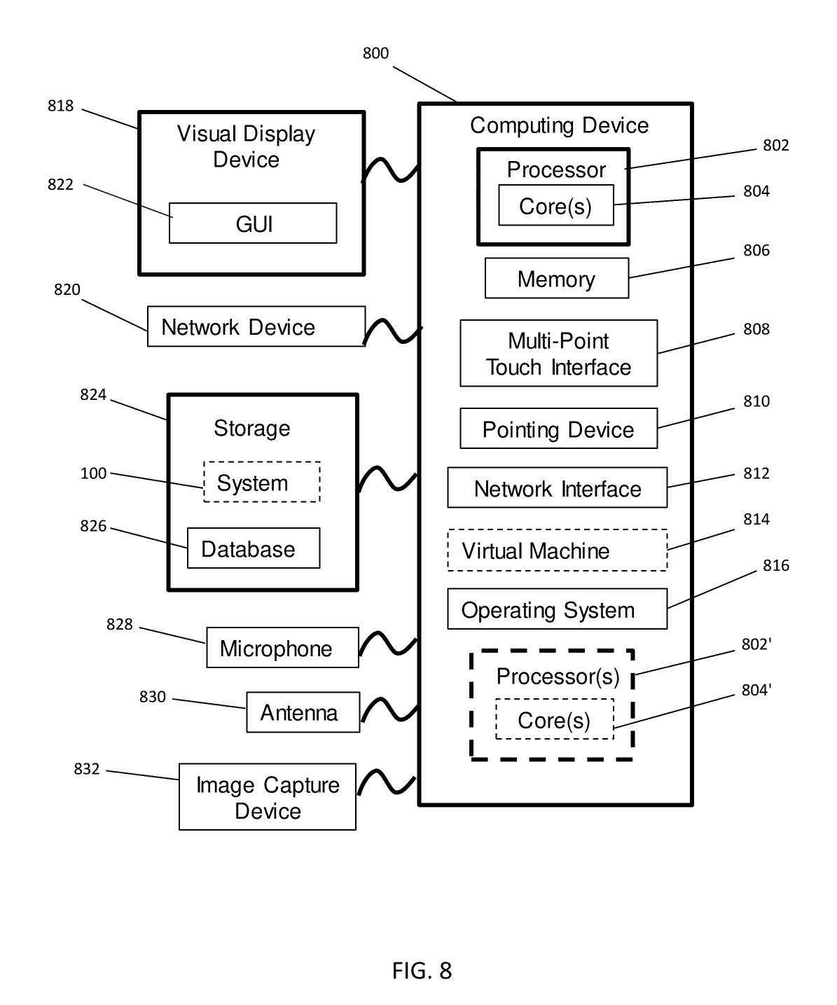

The client device 710 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The device 710 can include one or more components described in relation to computing device 800 shown in FIG. 8. The device 710 may be used by a user to provide feedback on the classified document images. Exemplary user interface 600 may be displayed on the device 710 to collect feedback and user input, and the user may indicate that the classification is accurate or inaccurate.

The device 710 may connect to network 705 via a wired or wireless connection. The device 710 may include one or more applications such as, but not limited to a web browser application, and the like. The device 710 may also include one or more components of system 100 described in relation to FIG. 1, and may perform one or more steps described in relation to FIG. 2.

The server 720 may include one or more processors and the image processing module 110 described in relation to FIG. 1. The server 720 may be configured to process images, clean up images, remove noise and prepare the images for OCR and segmentation. The server 720 may retrieve document images from the database(s) 740.

The server 730 may include one or more processors, and may include the image segmentation module 120, the segment filtering module 130, the classification module 140, and/or the validation module 150 described in relation to FIG. 1.

Each of the servers 720, 730 and the database(s) 740 is connected to the network 705 via a wired or wireless connection. The server 720, 730 includes one or more computers or processors configured to communicate with the client device 710, and database(s) 740 via network 705. The server 720, 730 hosts one or more applications, websites or systems accessed by the device 710 and/or facilitates access to the content of database(s) 740. Database(s) 740 comprise one or more storage devices for storing data and/or instructions (or code) for use by the device 710 and the servers 720, 730. The database(s) 740, and/or the server 720, 730 may be located at one or more geographically distributed locations from each other or from the device 710. Alternatively, the database(s) 740 may be included within the server 720, 730.

FIG. 8 is a block diagram of an exemplary computing device 800 that may be used to implement exemplary embodiments of the automated document classification system 100 described herein. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 806 included in the computing device 800 may store computer-readable and computer-executable instructions or software for implementing exemplary embodiments of the automated document classification system 100. The computing device 800 also includes configurable and/or programmable processor 802 and associated core 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling system hardware. Processor 802 and processor(s) 802′ may each be a single core processor or multiple core (804 and 804′) processor.

Virtualization may be employed in the computing device 800 so that infrastructure and resources in the computing device may be shared dynamically. A virtual machine 814 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user may interact with the computing device 800 through a visual display device 818, such as a computer monitor, which may display one or more graphical user interfaces 822 that may be provided in accordance with exemplary embodiments. The computing device 800 may include other I/O devices for receiving input from a user, for example, a keyboard or any suitable multi-point touch interface 808, a pointing device 810 (e.g., a mouse), a microphone 828, and/or an image capturing device 832 (e.g., a camera or scanner). The multi-point touch interface 808 (e.g., keyboard, pin pad, scanner, touch-screen, etc.) and the pointing device 810 (e.g., mouse, stylus pen, etc.) may be coupled to the visual display device 818. The computing device 800 may include other suitable conventional I/O peripherals.

The computing device 800 may also include one or more storage devices 824, such as a hard-drive, CD-ROM, or other computer readable media, for storing data and computer-readable instructions and/or software that implement exemplary embodiments of the automated document classification system 100 described herein. Exemplary storage device 824 may also store one or more databases for storing any suitable information required to implement exemplary embodiments. For example, exemplary storage device 824 can store one or more databases 826 for storing information, such scanned document images, processed images, segmented images and text blocks, classification information for document images, validation/feedback from user, and/or other information to be used by embodiments of the system 100. The databases may be updated manually or automatically at any suitable time to add, delete, and/or update one or more items in the databases.

The computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 800 can include one or more antennas 830 to facilitate wireless communication (e.g., via the network interface) between the computing device 800 and a network. The network interface 812 may include a built-in network adapter, network interface card, PCMCIA network card, card bus network adapter, wireless network adapter, USB network adapter, modem or any other device suitable for interfacing the computing device 800 to any type of network capable of communication and performing the operations described herein. Moreover, the computing device 800 may be any computer system, such as a workstation, desktop computer, server, laptop, handheld computer, tablet computer, mobile computing or communication device, ultrabook, internal corporate devices, or other form of computing or telecommunications device that is capable of communication and that has sufficient processor power and memory capacity to perform the operations described herein.

The computing device 800 may run operating system 816, such as versions of the Microsoft® Windows® operating systems, the different releases of the Unix and Linux operating systems, versions of the MacOS® for Macintosh computers, versions of mobile device operating systems (e.g., Apple® iOS, Google® Android™, Microsoft® Windows® Phone OS, BlackBerry® OS, and others), embedded operating systems, real-time operating systems, open source operating systems, proprietary operating systems, or other operating systems capable of running on the computing device and performing the operations described herein. In exemplary embodiments, the operating system 816 may be run in native mode or emulated mode. In an exemplary embodiment, the operating system 816 may be run on one or more cloud machine instances.

The following description is presented to enable any person skilled in the art to create and use a computer system configuration and related method and article of manufacture to automatically classify regulatory reports. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for automatically processing and classifying regulatory reports, the system comprising:
a database storing a plurality of document images of disparate regulatory reports; and
a server equipped with one or more processors and in communication with the database, the server configured to execute an image processing module, an image segmentation module, a segment filtering module, classification module, and a validation module, wherein the image processing module when executed:
removes noise from each of the plurality of document images;
aligns each of the plurality of document images; and
prepares each of the plurality of document images for optical character recognition (OCR);
wherein the image segmentation module when executed:
segments each of the plurality of document images into multiple defined segments, where the segments are smaller than the corresponding document image;
converts each of the defined segments into corresponding text blocks using OCR;
wherein the segment filtering module when executed:
identifies relevant segments by analyzing the corresponding text blocks and determining that the segment indicates a regulatory violation;
wherein the classification module when executed:
executes a trained machine learning model on the relevant segments of each of the plurality of document images;
automatically classifies each of the plurality of document images into a regulatory category; and
transmits data relating to the classification of each of the plurality of document images to a client device displaying a user interface; and
wherein the validation module when executed:
receives input from the client device via the user interface indicating the classification of a document image of the plurality of document images is accurate or inaccurate; and
transmitting the input as feedback to the classification module to retrain the machine learning model.

2. The system of claim 1, wherein the trained machine learning model is a deep learning neural network model.

3. The system of claim 1, wherein the trained machine learning model is a naïve Bayes classifier model.

4. The system of claim 1, wherein the trained machine learning model is a natural language processing model.

5. The system of claim 1, wherein the trained machine learning model is a tree-based classifier model.

6. The system of claim 1, wherein the trained machine learning model is a logistic regression model.

7. The system of claim 1, wherein the trained machine learning model is a support vector machine model.

8. The system of claim 1, wherein the image processing module when executed implements threshold calculation techniques.

9. The system of claim 1, wherein the image processing module when executed implements dilation and erosion techniques.

10. The system of claim 1, wherein the segment filtering module when executed implements font-based segment filtering.

11. The system of claim 1, wherein the image segmentation module when executed implements segmentation based on white space and line space in the document image.

12. The system of claim 1, wherein the classification module further automatically classifies each of the document image into a sub-category.

13. A method for automatically processing and classifying regulatory reports, the method comprising:
receiving a plurality of document images of disparate regulatory reports;
storing the plurality of document images in a database;
removing noise from each of the plurality of document images;
aligning each of the plurality of document images;
preparing each of the plurality of document images for optical character recognition (OCR);
segmenting each of the plurality of document images into multiple defined segments, where the segments are smaller than the corresponding document image;
converting each of the defined segments into corresponding text blocks using OCR;
identifying relevant segments by analyzing the corresponding text blocks and determining that the segment indicates a regulatory violation;
executing a trained machine learning model on the relevant segments of each of the plurality of document images;
automatically classifying each of the plurality of document images into a regulatory category;
transmitting data relating to the classification of each of the plurality of document images to a client device displaying a user interface;
receiving input from the client device via the user interface indicating the classification of a document image of the plurality of document images is accurate or inaccurate; and
transmitting the input as feedback to the trained machined learning model to retrain the machine learning model.

14. The method of claim 13, wherein the trained machine learning model is a deep learning neural network model.

15. The method of claim 13, wherein the trained machine learning model is a naïve Bayes classifier model.

16. The method of claim 13, wherein the trained machine learning model is a natural language processing model.

17. The method of claim 13, further comprising implementing threshold calculation techniques for processing each of the plurality of document images.

18. The method of claim 13, further comprising implementing font-based segment filtering to identify the relevant segments.

19. The method of claim 13, further comprising wherein the image segmentation module when executed implements segmentation based on white space and line space in the document image.

20. A non-transitory machine-readable medium storing instructions executable by a processing device, wherein execution of the instructions causes the processing device to implement a method for automatically processing and classifying regulatory reports, the method comprising:
receiving a plurality of document images of disparate regulatory reports;
storing the plurality of document images in a database;
removing noise from each of the plurality of document images;
aligning each of the plurality of document images;
preparing each of the plurality of document images for optical character recognition (OCR);
segmenting each of the plurality of document images into multiple defined segments, where the segments are smaller than the corresponding document image;
converting each of the defined segments into corresponding text blocks using OCR;
identifying relevant segments by analyzing the corresponding text blocks and determining that the segment indicates a regulatory violation;
executing a trained machine learning model on the relevant segments of each of the plurality of document images;
automatically classifying each of the plurality of document images into a regulatory category;
transmitting data relating to the classification of each of the plurality of document images to a client device displaying a user interface;
receiving input from the client device via the user interface indicating the classification of a document image of the plurality of document images is accurate or inaccurate; and
transmitting the input as feedback to the trained machined learning model to retrain the machine learning model.
